(19) United States
(12) Patent Application Publication
(10) Pub. No.: US 2008/0041646 A1
(43) Pub. Date: Feb. 21, 2008

(54) Hybrid power train system for vehicle

(76) Inventors: Hee-Ra Lee, Anyang-si (KR); Yeon-Ho Kim, Suwon-si (KR); Kyung-Ha Kim, Yongin-si (KR); Tal-Chul Kim, Bucheon-si (KR); Joo-Woong Yoon, Seoul (KR); Wan-Soo Kim, Hwasung-si (KR); Seong-Jae Song, Seoul (KR); Kyung-Won Hwang, Uijeongbu-si (KR); Gwang-Seob Shin, Ansan-si (KR); In-Pil Yoo, Hwasung-si (KR); Jong-Hyun Kim, Hwasung-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/590,991

(22) Filed: Oct. 31, 2006

(30) Foreign Application Priority Data
Aug. 10, 2006 (KR) 10-2006-0075541

(51) Int. Cl. B60K 6/00

(52) U.S. Cl. 180/65.2; 903/922

(57) ABSTRACT

A hybrid power train system for a vehicle that has a simple configuration and can efficiently transmit power generated from an engine and a motor to driving wheels while using a general transmission, and obtain high regenerative braking efficiency. The configuration includes coaxial shafts between rotational components.

### CROSS-REFERENCE TO RELATED APPLICATIONS

The present application is based on, and claims priority from, Korean Application Serial Number 10-2006-0075541, filed on Aug. 10, 2006, the disclosure of which is hereby incorporated by reference herein in its entirety.

### FIELD OF THE INVENTION

The present invention relates to a hybrid power train system for a vehicle, and more particularly, to a technology for a hybrid power train system for a vehicle that is adapted to drive the vehicle by using power of a motor generator (hereinafter, called a “motor”) and an engine, and to be universally connected to a general transmission.

### BACKGROUND OF THE INVENTION

A hybrid vehicle that improves fuel efficiency and reduces emission of hazardous materials using complementary driving characteristics of an engine and a motor typically requires a separate power train system designed for the hybrid vehicle such that power generated from the engine and power generated from the motor are appropriately supplied to driving wheels and electricity is efficiently charged using the motor for regenerative braking upon braking.

Therefore, a power train system that is separately designed between the motor and the engine and driving wheels is generally used. However, costs of design and manufacture of such a new power train system increase the price of the vehicle.

### SUMMARY OF THE INVENTION

Embodiments of the present invention provide a hybrid power train system for a vehicle that has a simple configuration and can efficiently transmit power generated from an engine and a motor to driving wheels while using a known transmission, and obtain high regenerative braking efficiency.

A hybrid power train system in a vehicle according to an embodiment of the present invention includes an engine, a clutch having a clutch input shaft and a clutch output shaft that are co-axial with an output shaft of the engine, a motor having a rotor connected to the clutch output shaft in a state where a torque converter input shaft is coaxially connected with the clutch output shaft, and a torque converter having a converter input shaft and a converter output shaft that are co-axial with the clutch output shaft, and being connected to a transmission.

### BRIEF DESCRIPTION OF THE DRAWINGS

For a better understanding of the nature and objects of the present invention, reference should be made to the following detailed description with the accompanying drawings, in which:

FIG. 1 is a schematic diagram showing a configuration of a hybrid train system for a vehicle according to an embodiment of the present invention;

FIG. 2 is a schematic diagram illustrating a state where a clutch is released and a vehicle is driven by a motor according to an embodiment of the present invention;

FIG. 3 is a schematic diagram illustrating a process in which an engine starts by a motor during driving according to an embodiment of the present invention; and

FIG. 4 is a schematic diagram illustrating a state where a vehicle is driven by a motor and an engine according to an embodiment of the present invention.

### DETAILED DESCRIPTION OF THE PREFERRED EMBODIMENTS

A preferred embodiment of the present invention will now be described with reference to the accompanying drawings.

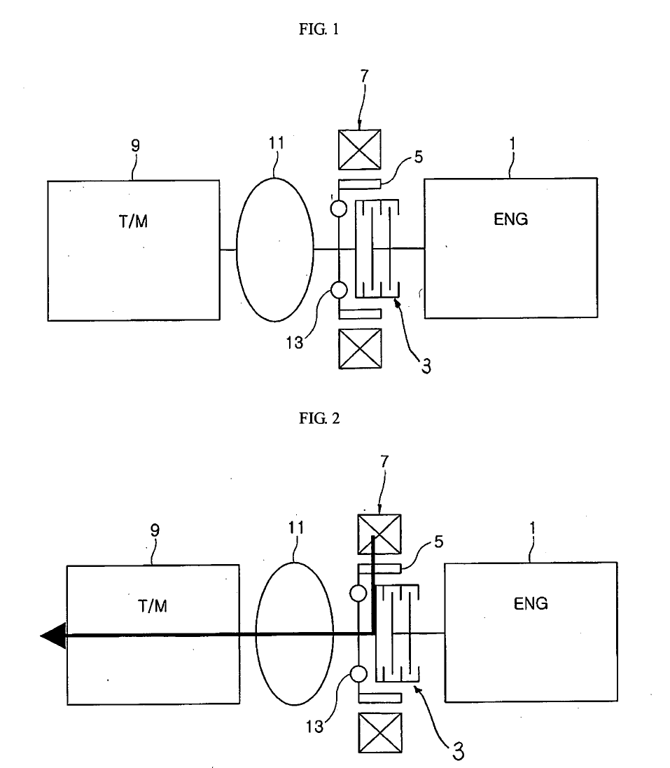

Referring to FIG. 1, a hybrid power train system for a vehicle according to an embodiment of the present invention includes an engine 1, clutch 3, motor 7, transmission 9 and torque converter 21. The clutch 3 has a clutch input shaft and a clutch output shaft that are co-axial with the output shaft of engine 1. The clutch input shaft is coaxially connected to the engine output shaft. The clutch input shaft and engine output shaft may be connected by an in-line coupling or may be formed integrally as a single shaft member. Motor 7 has a rotor 5 connected to the clutch output shaft in a state where the torque converter input shaft is coaxially connected with the clutch output shaft. The torque converter input shaft and the clutch output shaft may be connected by an in-line coupling or may be formed integrally as a single shaft member. The torque converter 11 has a converter input shaft and a converter output shaft that are co-axial with the clutch output shaft, and connected to transmission 9. The torque converter output shaft and transmission input shaft are coaxially connected, and may be connected by an in-line coupling or may be formed integrally as a single shaft member. Clutch 3 and motor 7 that are co-axial with each other are interposed between the automatic transmission having a known torque converter 11 and the engine.

Clutch 3 is located inside rotor 5 of motor 7 in a radial direction. Motor 7 and clutch 3 share space, such that the total length of the power train is relatively reduced to provide a compact configuration. Other suitable clutch type may be selected by persons of ordinary skill in the art based on the teachings herein. Clutch 3 may be a wet multiplate clutch whose duty is controlled by a hydraulic pressure. Rotor 5 is connected to the clutch output shaft through a torsional damper 13 so as to absorb and buffer a rotational shock force.

A part of a power train state of a hybrid power train system with the above-described configuration will now be described with reference to FIGS. 2 to 4.

FIG. 2 shows a driving state for a vehicle by motor 7. That is, while clutch 3 is released, driving force generated from motor 7 is input to torque converter 11 through torsional damper 13, and a rotational force output from torque converter 11 is transmitted to transmission 9, and finally, to the driving wheels. In this state, since engine 1 is disconnected from the power train system by clutch 3, the revolution inertia of engine 1 does not consume the driving force of motor 7. Therefore, an efficient driving state of the motor can be realized. In contrast, in case of regenerative braking when driving force flows backward through the driving wheels, efficient battery charging can be made by the generation of motor 7 in a state where the revolution inertia of engine 1 is excluded.

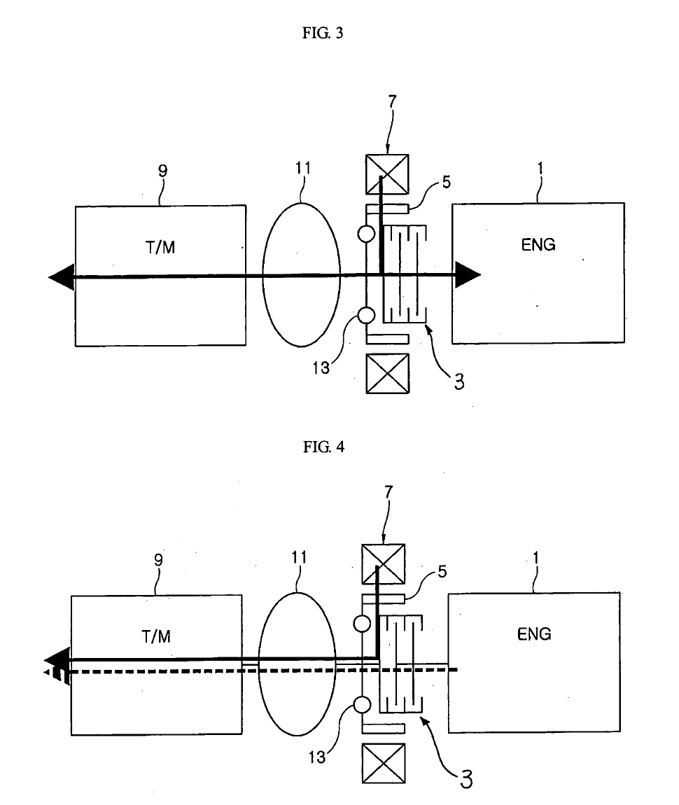

FIG. 3 shows a case where engine 1 starts by motor 7 during driving. Clutch 3 is subject to slip control, to thereby start engine 1. Clutch 3 is released immediately after engine 1 starts such that engine 1 is isolated until engine 1 operates at a normal number of rotations. When engine 1 operates at a normal number of rotations, and thus the speed of engine 1 is synchronized with the speed of motor 7, the clutch is directly coupled again and the driving wheels are driven by motor 7 and engine 1.

As shown in FIG. 4, the driving force of motor 7 is auxiliarily added to the driving force of engine 1, such that power is transmitted to the driving wheels through torque converter 11 and transmission 9. As such, when power of engine 1 is being transmitted to torque converter 11 through clutch 3, the driving force is not generated entirely from motor 7 but a part of power supplied from engine 1 is drawn, such that engine 1 functions as a generator. Therefore, it is controlled such that discharged batteries can be charged again.

According to embodiments of present invention, there is provided a hybrid power train system for a vehicle that has a simple configuration and can efficiently transmit power generated from an engine and a motor to driving wheels while using a known transmission, and obtain high regenerative braking efficiency.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A hybrid power train system for a vehicle, comprising:
an engine;
a clutch having a clutch input shaft and a clutch output shaft that are co-axial with an output shaft of said engine;
a motor having a rotor connected to said clutch output shaft; and
a torque converter having a converter input shaft and a converter output shaft that are co-axial with said clutch output shaft, and being connected to a transmission.

2. The system as defined in claim 1, wherein said clutch is located inside said rotor of said motor in a radial direction, and said rotor is connected to said clutch output shaft through a torsional damper.
